(19) United States
(12) Patent Application Publication
(10) Pub. No.: US 2022/0300911 A1
(43) Pub. Date: Sep. 22, 2022

(54) GRAPHICAL USER INTERFACE FOR RESERVING WORK LOCATION

(71) Applicant: Nook Technologies, Inc., Cantley (CA)

(72) Inventors: Marc GINGRAS, Cantley (CA); Jean-Philippe LESPINASSE, Brossard (CA); Rian Boyd ROBERTSON, Ottawa (CA); Chadwick Russell CARLSON, Ottawa (CA)

(21) Appl. No.: 17/699,897

(22) Filed: Mar. 21, 2022

Related U.S. Application Data
(60) Provisional application No. 63/164,018, filed on Mar. 22, 2021.

(51) Int. Cl. G06Q 10/10; G06Q 10/02; G06F 3/0482

(52) U.S. Cl. CPC G06Q 10/1095; G06Q 10/02; G06F 3/0482

(57) ABSTRACT

A method and system for managing occupancy of a workplace location in time is provided. The method comprising receiving a reservation request comprising an expected location identifier of the expected location and a time slot indication of the time slot; generating and transmitting a refusal of the reservation request to the client device if a location counter is equal to a full capacity of the location; displaying a calendar user interface with expected location badges of the expected locations for the plurality of users for each day using personal thumbnails, the personal thumbnails being located in the calendar user interface based on the reservation request received from each client device; generating and displaying a spatial-relationship visual indicator which maps a selection of the personal thumbnails related to users having all selected one specific location from the received expected locations.

### CROSS-REFERENCE

The present application claims benefit of or priority to U.S. application No. 63/164,018, filed Mar. 22, 2021, the entirety of which is incorporated herein by reference.

### FIELD

The subject matter disclosed generally relates to methods for the automated management of workforce and building space. More specifically, it relates to a computer-implemented method for managing a calendar for workspace use and a computer-implemented method for performing a corresponding graphical user interface.

### BACKGROUND

Since 2020, there has been a drastic change in terms of workplace occupancy. Sanitary restrictions have reduced workplace occupancy to a minimum, favoring remote working as never before.

Also, organizations looking at the future of their workplace management may determine that it may be financially advantageous to have less workspace available than the total occupancy of the workplace, in a context where there is permanently a portion of the workforce works from home, although each person taken individually may work from either home or office.

There is a lack of tools to ensure that occupancy is adequately predicted and reserved such that use is optimal (maximal) while avoiding lack of working space due to too many employees coming to office on the same day. There is also a lack of tools to ensure that sanitary restrictions may be satisfied, for example if maximum capacity is set per floor or per portion of the floor in the building.

### SUMMARY

It is an object of the present technology to ameliorate at least some inconveniences present in the prior art. It is an object of the present technology to improve the management of the occupancy of the working spaces.

According to an aspect of the disclosure, there is provided a method for managing occupancy of a workplace location in time, the method being executed by a server comprising a processor and a computer-readable memory storing instructions to be executed by the processor and a location-time database, the method comprising:

displaying a selection user interface at a client device for a user among a plurality of users for selecting, by the user, an expected location for a given time slot;

receiving a reservation request, at the server from the client device, the reservation request comprising an expected location identifier of the expected location and a time slot indication of the time slot;

generating and transmitting a refusal of the reservation request to the client device if a location counter is equal to a location capacity of the location, the location counter representing the number of previously received expected location identifiers of the expected location from the plurality of users;

displaying a calendar user interface with an expected location badge of the expected location for each day using personal thumbnails corresponding the plurality of users, each personal thumbnail corresponding to one user of the plurality of users, the personal thumbnails being located in the calendar user interface based on the reservation request received from each client device; and

generating and displaying, on the calendar user interface of the user display of the client device, a spatial-relationship visual indicator which maps a selection of the personal thumbnails related to users having all selected one specific location from the received expected locations, each personal thumbnail relating to a reservation of one user of the specific location having an internal location capacity, the internal location capacity being independent from the working location capacity of the workplace location.

According to an embodiment, there is further provided the step of generating, based on a portion of a day for which the expected location is reserved for a first personal thumbnail, and displaying a visual modifier on the first personal thumbnail, the visual modifier indicating that an expected occupancy of the expected location for which one of the first personal thumbnail is displayed in the calendar user interface is for the portion of the day only, the portion of the day being smaller than a whole day.

According to an embodiment, the visual modifier on the at least one of the personal thumbnails displays an angular coverage which is representative of the portion of the day for which the occupancy is expected.

According to an embodiment, there is further provided the step of generating a timeline feed comprising a combined list of calendar reservation notifications and quick actions displayed in a chronological order.

According to an embodiment, there is further provided the step of generating, based on an activity received from the client device, and displaying along with the personal thumbnail, an activity indicator which represents activity or state-of-mind that the user indicated through the selection user interface.

According to another aspect of the disclosure, there is provided a system for managing occupancy of a workplace location in time, the system comprising a server comprising a processor and a computer-readable memory storing instructions to be executed by the processor and a location-time database, the processor being configured to:

display a selection user interface at a client device for a user among a plurality of users for selecting, by the user, an expected location for a given time slot;

receive a reservation request, at the server from the client device, the reservation request comprising an expected location identifier of the expected location and a time slot indication of the time slot;

generate and transmitting a refusal of the reservation request to the client device if a location counter is equal to a capacity of the location upon receiving the expected location identifiers from the plurality of users;

display a calendar user interface with expected location badges of the expected locations for the plurality of users for each day using personal thumbnails, each personal thumbnail corresponding to one user of the plurality of users, the personal thumbnails being located in the calendar user interface based on the reservation request received from each client device; and

generate and display, on the calendar user interface of the user display of the client device, a spatial-relationship visual indicator which maps a selection of the personal thumbnails related to users having all selected one specific location from the received expected locations, each personal thumbnail relating to a reservation of one user of the specific location having an internal location capacity, the internal location capacity being independent from the working location capacity of the workplace location.

According to an embodiment, the processor is further adapted to generate, based on a portion of a day for which the expected location is reserved for a first personal thumbnail, and displaying a visual modifier on the first personal thumbnail, the visual modifier indicating that an expected occupancy of the expected location for which one of the first personal thumbnail is displayed in the calendar user interface is for the portion of the day only, the portion of the day being smaller than a whole day.

According to an embodiment, the visual modifier on the at least one of the personal thumbnails displays an angular coverage which is representative of the portion of the day for which the occupancy is expected.

According to an embodiment, the processor is further adapted to generate a timeline feed comprising a combined list of calendar reservation notifications and quick actions displayed in a chronological order.

According to an embodiment, the processor is further adapted to generate, based on an activity received from the client device, and displaying along with the personal thumbnail, an activity indicator which represents activity or state-of-mind that the user indicated through the selection user interface.

### BRIEF DESCRIPTION OF THE DRAWINGS

Further features and advantages of the present disclosure will become apparent from the following detailed description, taken in combination with the appended drawings, in which:

FIG. 1 is a screenshot illustrating a graphical user interface as displayed on a client device and which shows a calendar including expected location thumbnails for the person to which the client account is linked, a list of personal thumbnails of participating people indicating reserved occupancy of locations for each day or portion of day in the calendar, further indicating, with a visual indicator, spatial relationships relating to reserved occupancies between people to which the personal thumbnails belong, according to an embodiment;

FIG. 2 is a screenshot illustrating a graphical user interface for editing activity statuses, location and tasks for each day or portion of day, which results in an update in the graphical user interface of FIG. 1, prompting the user to select and specify travelling details for the travel activity status, according to an embodiment;

FIG. 3 is a screenshot illustrating another graphical user interface for editing activity statuses, location and tasks for each day or portion of day, which results in an update in the graphical user interface of FIG. 1, prompting the user to select and specify details for the activity status of working privately, according to an embodiment;

FIG. 4 is a screenshot illustrating another graphical user interface for editing activity statuses, location and tasks for each day or portion of day, which results in an update in the graphical user interface of FIG. 1, prompting the user to select and specify details for the activity status of working focused, according to an embodiment;

FIG. 5 is a screenshot illustrating another graphical user interface for editing activity statuses, location and tasks for each day or portion of day, which results in an update in the graphical user interface of FIG. 1, prompting the user to select and specify details for the activity status of working in an open for collaboration status, according to an embodiment;

FIG. 6 is a screenshot illustrating a graphical user interface for displaying the activity status and other detailed information of other users, according to an embodiment;

FIG. 7 is a screenshot illustrating a graphical user interface for managing connections, including closest collaborators in an organization for limiting the number of thumbnails to display or displaying thumbnails including a preferred location in the GUI for the closest collaborator, according to an embodiment;

FIG. 8A is a schematic diagram illustrating a system with back-end and front-end for implementing the method, according to an embodiment;

FIG. 8B is another schematic diagram illustrating the system of FIG. 8A, according to an embodiment;

FIG. 9 is a flowchart illustrating the method for managing an expected occupancy of a workplace location, according to an embodiment; and

FIG. 10 is a screenshot illustrating a graphical user interface for managing home/travel/away statuses, according to an embodiment.

It will be noted that throughout the appended drawings, like features are identified by like reference numerals.

### DETAILED DESCRIPTION

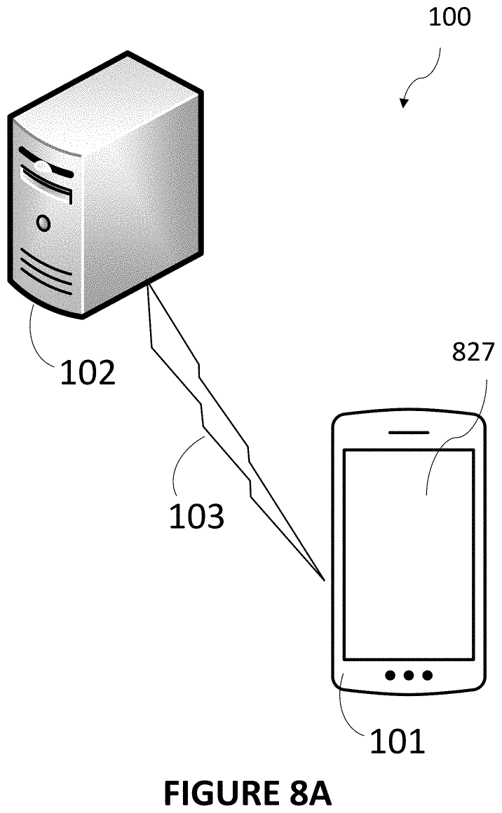

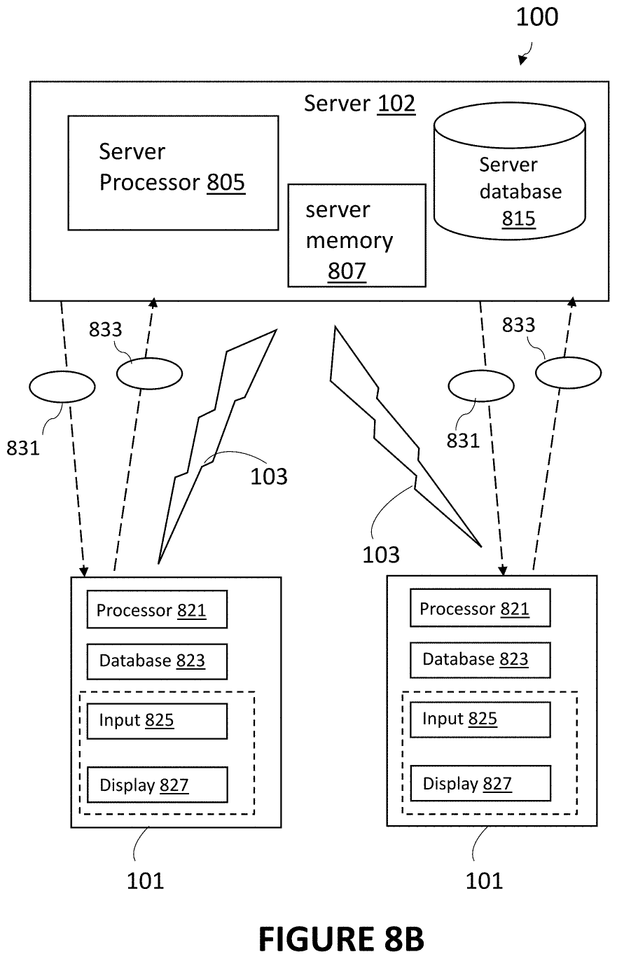

There is described herein a method for managing occupancy of a workplace location in time. The method comprises producing a graphical user interface (GUI) and operating the graphical user interface. The method is executed by a system 100 comprising a front-end client device 101, as shown in FIG. 8A, in communication, using a communication network 103 such as the internet, with a server 102 for performing back-end operations. The method as described herein is configured to perform an efficient management of locations in a working environment, especially in the context of limited availability of working space, which can be due to a workforce being larger than the working space capacity, to sanitary restrictions or other limiting aspects.

The method as described herein allows people (employees, independent workers or the like) to reserve a location in the working environment having limited space. Similarly, location reservation for a given time slot (typically, a day or a portion of day such as a half-day AM/PM) is prevented by the server 102 operating the method if the reserved locations (i.e., reserved by all users) for that time slot (a day or a portion of a day) has reached the space limit.

FIG. 8B illustrates that the server 102 comprises a server processor 805 configured to execute instructions stored in a computer-readable memory 807, and a database 815. The client device 101 comprises a client device processor 821, a client device database 823, an input element 825 (for example, a keyboard, a mouse, and/or a touch screen configured to receive the user's input) and a client device display 827. In some embodiments, the input element 825 and the client device display 827 may be implemented as a touch screen.

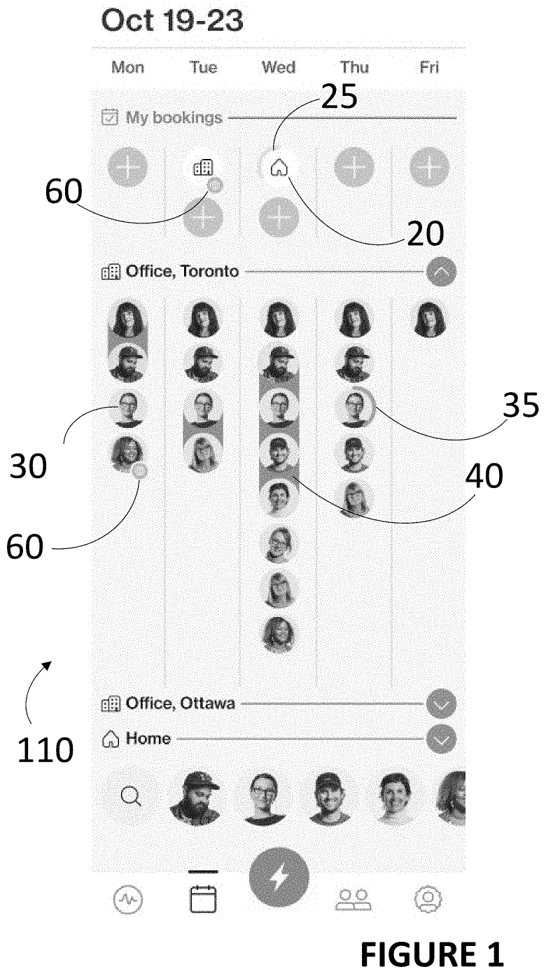

FIG. 1 is a screenshot illustrating a calendar graphical user interface 110 (GUI) as displayed on the client device display 827 of the client device 101 (FIGS. 8A, 8B) and which shows a calendar including expected location thumbnails 20 for the person to which the client account is linked, a list of personal thumbnails 30 of participating people (users) indicating reserved occupancy of locations for each day or portion of day in the calendar, further indicating, with a spatial-relationship visual indicator 40, spatial relationships relating to reserved occupancies between people to which the personal thumbnails belong.

The calendar as shown comprises at least one day or a portion of a day. Typically, the calendar comprises a week or work week (Monday through Friday), as shown in FIG. 1.

For each day, the expected location thumbnails 20 for the person to which the client account is linked is shown. This information is provided by the user (i.e., the person to which the client account is linked) for each day, indicating through a query that for a given day, that the user expects to be working from home, or from a first office location, or from a second (third, fourth, etc.) office location, or from outside (i.e., business trip) or any other one of expected locations, or on vacation.

Depending on the selection made by the user for each day or portion of day, the corresponding expected location thumbnail 20 is shown in the GUI for that user on that day or portion of day, as shown in FIG. 1. An unselected expected location results in the absence of an expected location thumbnail 20 unless a default location and corresponding expected location thumbnail 20 are set by the user.

The GUI 110 comprises a public calendar section which is generally not personal as it shows to all users the identities of users having reserved a given working location for a given day or portion of day.

As shown in FIG. 1, this section is divided in subsections which correspond to a given location, e.g., first working location and second working location, where the reservations of expected working locations are shown using a list of personal thumbnails 30, wherein each user has an account/identity with corresponding personal thumbnail 30. More specifically, in this portion of the GUI, there is shown a list of all the users having reserved a location as their expected working location for that day and that location (i.e., the combination thereof). This information is provided by the server 102 (back-end) which collects and stores the reservations for all users, which is then made available for all to see, with personalization options described below. In other words, the server processor 805 may send reservation prompt(s) 831 to the client device processor(s) 821 of the client device(s) 101. The server processor 805 receives a reservation request 833 provided by the user through the input element 825 of one or more client devices 101. Such reservation request 833 may comprise, for example, a user identification (ID), expected working location (and/or, in some embodiments, an internal location), and a reservation time (day, and, for example, time period).

The server processor 805 receives the reservation requests 833 and then stores the reservation request 833 in the server database 815. The server database 815 may thus have a database of reservation requests. In addition, the server processor 805 maps such reservation request to the working location (an/or internal location) and the date and, optionally, to a particular (requested) time slot.

Each working location may be characterized by a working location capacity. In some embodiment, each working location may correspond to one building, and to a plurality of (local, or, in other term, internal) locations within one building. The internal location may be, for example, a room or a floor. Such internal locations may be characterized by an internal location capacity.

The server 102 also implements business rules. When the location (working location and/or internal location) has reached a limit (working location capacity and/or internal location capacity) in terms of reservations (reservation requests 833) having been made fora time slot (i.e., when the expected occupancy has reached capacity), the server 102 prevents registering any further reservation by a user (in other terms, a reservation request received from the client device 101) for that location and time slot. Preventing registering when the working location capacity and/or internal location capacity has been reached may be performed by refusing user-proposed reservations (for example, by generating and transmitting a refusal to the client device 101) or by not offering any choice of reserving that location (for example, by modifying the prompt(s) 831) for that time slot as long as the location is at an expected full capacity (in other words, when the location counter is equal to the location capacity of that location). The server 102 may, however, manage cancelations or changes of expected locations and start allowing reservations again in view of the changes. For example, the client device 101 may send to the server 102 a cancelation request, and, in response to receiving such a cancelation request, the server 102 may dissociate the reservation that has been previously received from the same user for a reservation time slot, from the corresponding location and time slot.

According to an embodiment, the GUI 110 shows the personal thumbnail 30 for a given location and day, including the case in which a user has reserved a time slot for only a portion of a day (such as a half-day, AM or PM for example). As shown in FIG. 1, a visual modifier 35 can be generated on the GUI of all users to indicate that the personal thumbnail 30 of the user is present but implies only partial presence during the day (fraction of the day). In other words, the visual modifier 35 is generated to indicate that the reserved time slot corresponds only to a portion of a day. According to an embodiment, the visual modifier 35 is a colored contour on the personal thumbnail 30 of that user, having an angular coverage (for example, along at least a portion of a periphery, or a circumference, of the circular or oval personal thumbnail 30) which is representative of the expected portion of day where the user is expected to be at the location (working location and/or internal location) according to that user's reservation (based on the reservation request).

A similar visual modifier 25 may be provided on the expected location thumbnail 20 of the user, which is the same as the visual modifier 35 that the other users can see when they view the corresponding personal thumbnail 30 of the user in their own calendar.

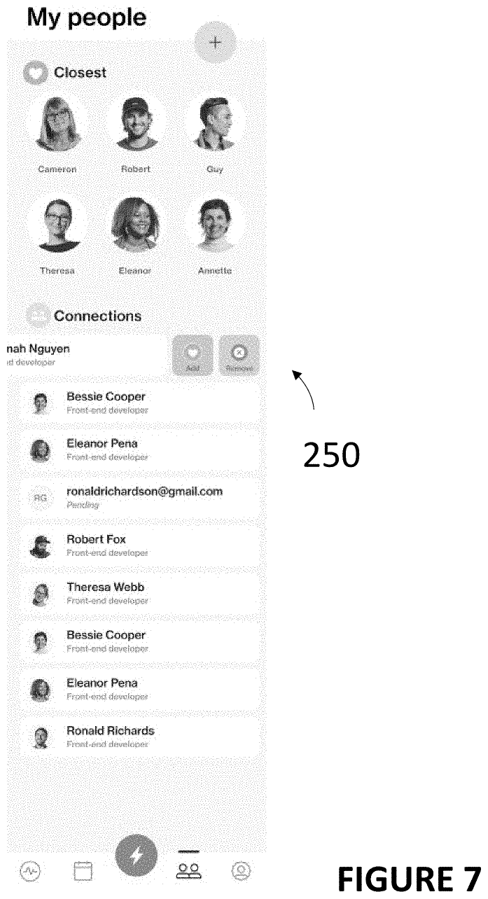

According to an embodiment, the GUI 110 shows only a limited selection (i.e., not everyone) of all users' personal thumbnails 30 that would otherwise be presented. This is useful in large organizations having locations with large capacities where the number of individual personal thumbnails 30 may be too great to be useful for all to see. In this case, and referring to FIG. 7, there may be presented a GUI 250 for the user to select preferred users, i.e., close colleagues who are either on the same team, on related teams, who have a hierarchical relationship or who are friends with each other. It can also include two levels: connections and closest connections for which the display in the calendar is prioritized. As shown in FIG. 7, the list of closest connections may be editable and may be personalized by each user to fit the user's needs. This personalization limits the number of personal thumbnails being presented in the calendar by displaying only the personal thumbnails of these users, making the calendar presentation unique to each user. Based on the selected colleagues (closest connections) by the user, the client device (the client device processor) may provide the list of the selected closest connections to the server, along with the reservation request or separately.

Typically, the personal thumbnail 30 of the user is shown in that user's calendar.

Referring to FIG. 1, according to an embodiment, there is shown a spatial-relationship visual indicator 40 in the calendar. The spatial-relationship visual indicator 40 is determined to be relevant by the server 102 by determining which exact location is to be used by a given user, using either a default user location (such as a dedicated office space) or using an ad-hoc specific location provided by the user making the reservation through the GUI 110, e.g., reserving a time slot at the working location specifying that a meeting room or office space will be reserved concurrently. All users having reserved a specific location among the working location which is predetermined to be related can then be grouped. Specific locations can be predetermined to be related if they are the same (e.g., the same meeting room), or if they belong to a predefined space, such as a floor or portion or floor. This is particularly useful if the specific location has a capacity per se, such as a meeting room (which has its own capacity regardless of the capacity of the whole building) or of work spaces which can have a number of working stations (again, that working space has its own capacity regardless of the capacity of the whole building), or a floor in the context of sanitary restrictions (each floor has its own capacity in view of sanitary restrictions regardless of the capacity of the whole building).

Such specific locations which are related and share their own independent capacity are therefore grouped together and, advantageously, once the server (and, more specifically, the server processor) has grouped them together (and, for example, stored into a spatial-relationship database), the front-end side displayed in the GUI 110 on the client devices 101 can show a spatial-relationship visual indicator 40 to indicate that all these people will share a specific location or space (internal location) being related and sharing a dedicated location capacity which is independent from (and smaller than) the working location capacity (e.g., the building capacity).

Still referring to FIG. 1, according to an embodiment, an activity indicator 60 is shown accompanying the displayed personal thumbnail 30, and/or accompanying the expected location thumbnail 20 of the user. According to an embodiment, the activity indicator 60 is a symbol which depends on the type of activity that the corresponding user indicated through the GUI 110 (by selecting from a list of activities). Examples of activities may include an indication that the user is working with a client, is traveling or commuting, is on break, is working from home, is working at a working location in focus, etc. In order to attribute a symbol, the number of possible activity statuses or categories thereof needs to be limited and the activities or categories thereof need to be predetermined. In at least one embodiment, the server 102 may prompt the user to select the activity from the list of activities, and the server processor, after receiving data of the selected activity (indicative of the user's activity) from the client device 101 and based on the selected activity generates the activity indicator 60 and displays the activity indicator 60 together with the personal thumbnail.

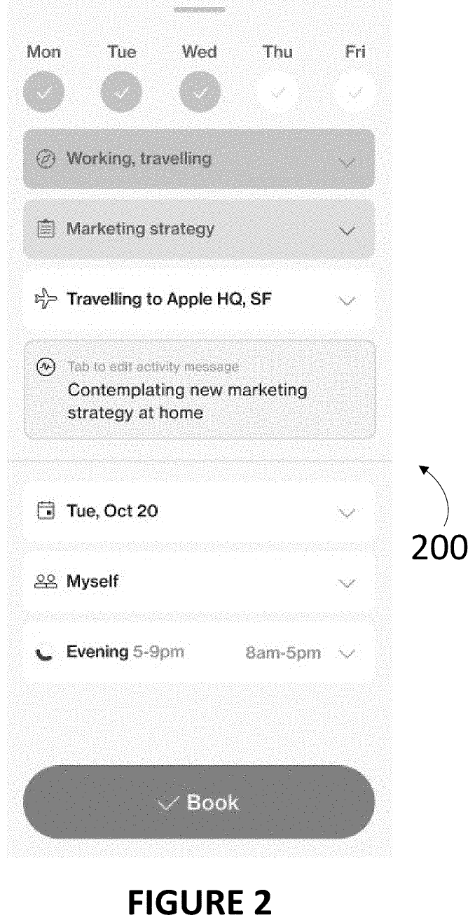

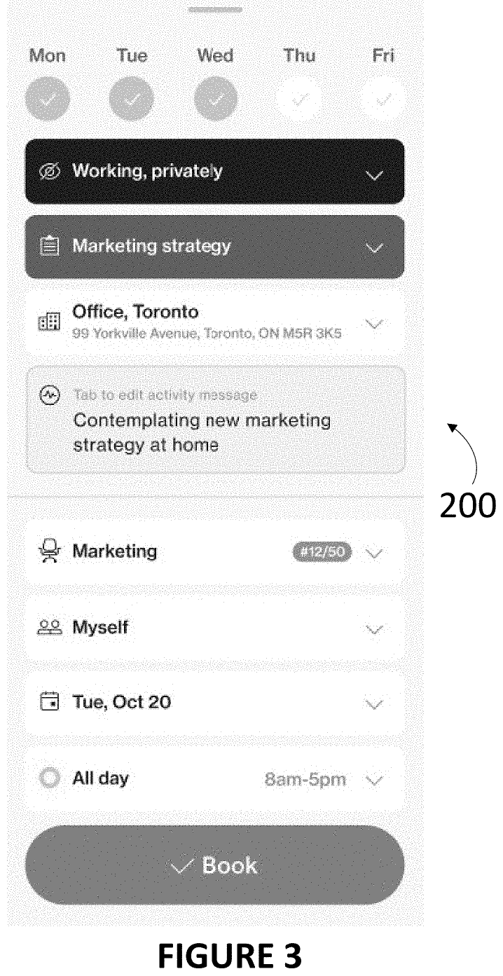

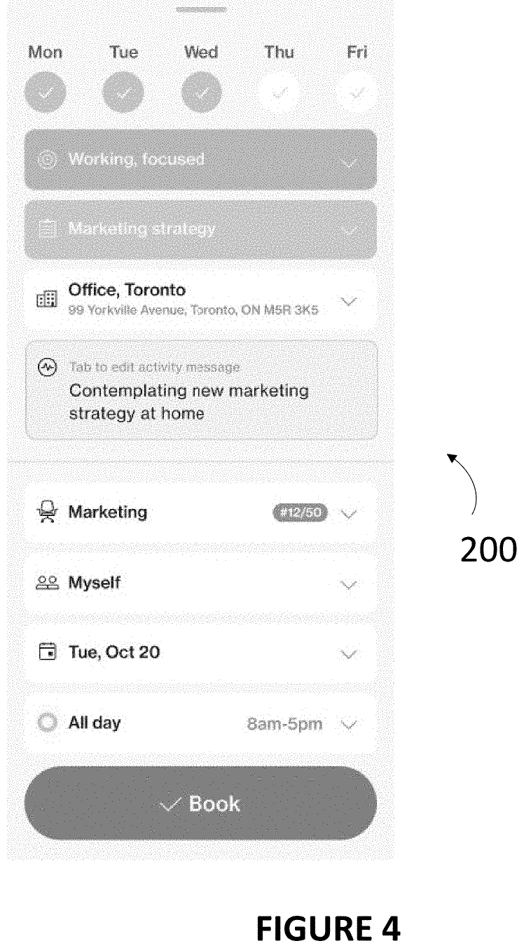

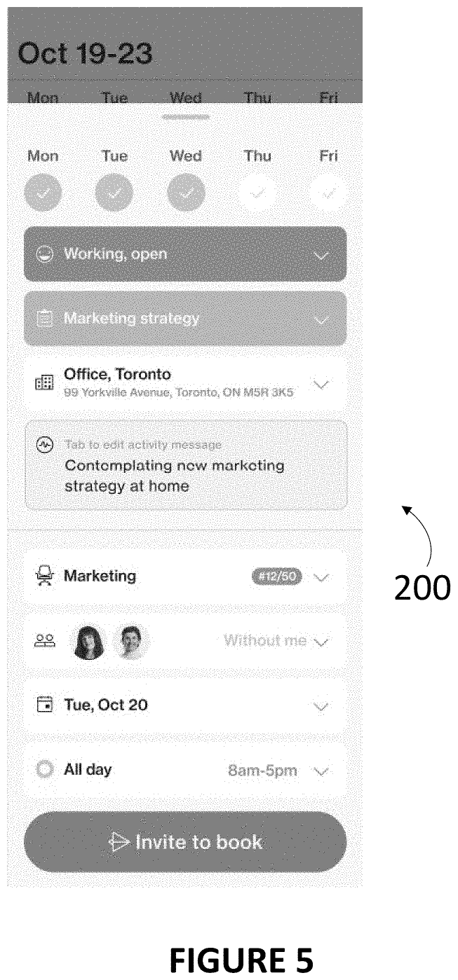

There may be a plurality of such activity indicators 60 for a user, including an activity message, a location status, a state of mind status, etc., which can be used in addition to each other. This is shown in FIGS. 2-5, illustrating various embodiments of an interface 200 for editing details of activities, which show that a state-of-mind activity, a location, a task and an activity message, can be selected and edited. Not all of them need to have an activity indicator 60, as the location may have been, preferably, already communicated in the GUI 110 by giving a particular location (in the GUI 110) of a personal thumbnail in the public calendar indicating expected working location, although state-of-mind, task and activity message can be represented by a symbol such as an activity indicator 60. Data regarding the selected activity is then transmitted to the server processor 805.

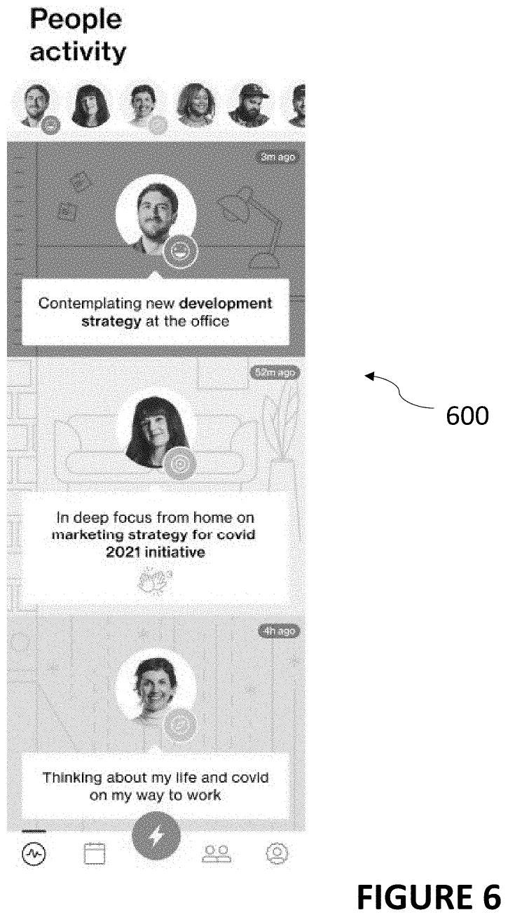

According to an embodiment, other people's activities or statuses can be consulted, as shown in FIG. 6. For example, reservation actions and status events can be presented as a timeline feed. According to an embodiment, the timeline feed is based on the closest connections. For example, the user may have chosen the closes connections earlier and the server may have stored the list of the closes connections for that particular user in the server database 815. In at least one embodiment, the server processor generates the GUI 600 (or generates instructions for the client device processor to generate the GUI 600) that displays on the client device display 827 the activities of the closest connections in a timeline. For this, the server processor 805 may search the server database 815 for the data related to the closest connections of the user and retrieve the activities stored in the database of those closest connections. In at least one embodiment, the list of team colleagues described above may be the same as the closest connections.

Such a timeline would preferably not be a repetition of the reservation events represented in the calendar. Rather, it would represent a timeline of when booking events are created and/or updated, and by who, to function as a list of notifications within a graphical user interface forming such a visual timeline with corresponding chronology of creation/update and actual communication to the user.

According to an embodiment, this timeline, and corresponding interface, may also comprise ‘quick status’ updates. The quick status updates may represent the events that do not take a significant portion of the day and may be created on an ad-hoc basis, which are not represented in the calendar view. For example, the timeline may notify that one of the closest connections (i.e., one of the other users that were, for example, identified as another user of the users if the closest connections) has stepped away for 15 minutes (assuming that this user has updated their status accordingly). In this case, the timeline as provided in FIG. 6 represents a combined list of calendar reservation updates and quick actions displayed in a chronological order, to provide an overview of activities of the closest connections (in other terms, of the users from the closest activities list).

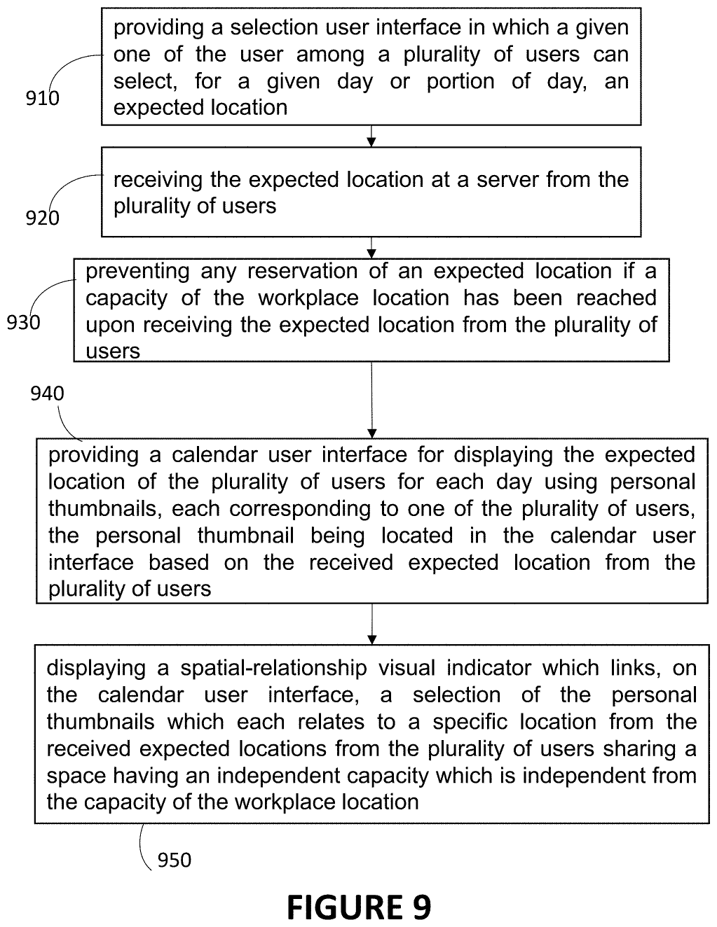

Now referring to FIG. 9, there is shown a method for managing an expected occupancy of a workplace location comprising the following steps.

At step 910 the server provides a selection user interface in which a given user among a plurality of users can select, for a given day or portion of day, an expected location. In other words, the server prompts the user to select the expected location and generating a reservation request, the reservation request comprising the expected location identifier of the expected location and a time slot indication of the time slot. A selection user interface is displayed at a client device for a user among a plurality of users in order the user to select, for a given time slot, an expected location.

At step 920, the server receives the reservation request from the client device reservation request comprising an expected location identifier of the expected location and a time slot indication of the time slot, the expected location being received at a server from the plurality of users.

At step 930, the server prevents any reservation of an expected location if a capacity of the workplace location has been reached upon receiving the expected location from the plurality of users. In other words, the server generates and transmits a refusal of the reservation request to the client device if a location counter is equal to a capacity of the location upon receiving the expected location identifiers from the plurality of users.

At step 940, a calendar user interface is provided on the display of the user device, where the expected of the plurality of users location is displayed for each day using personal thumbnails, each corresponding to one of the plurality of users, the personal thumbnail being located in the calendar user interface based on the received expected location from the plurality of users. In other words, the calendar user interface with expected location badges of the expected locations for the plurality of users is displayed for each day using personal thumbnails, each personal thumbnail corresponding to one user of the plurality of users, the personal thumbnails being located in the calendar user interface based on the reservation request received from each client device.

At step 950, a spatial-relationship visual indicator is generated and displayed on the calendar user interface of the user display of the client device. The spatial-relationship visual indicator links, on the calendar user interface, a selection of the personal thumbnails which each relates to a specific location from the received expected locations from the plurality of users sharing a space having an independent capacity which is independent from the capacity of the workplace location. The spatial-relationship visual indicator maps a selection of the personal thumbnails related to users having all selected one specific location from the received expected locations, each personal thumbnail relating to a reservation of one user of the specific location having an internal location capacity, the internal location capacity being independent from the working location capacity of the workplace location.

According to an embodiment, personal spaces and bookings can be distributed across a plurality of different workplaces/communities. Therefore, a user can be part of multiple workplaces (aka communities). In other words, the processor 805 may map the user and the personal thumbnail to more than one workplaces (working locations). A user can switch between their workspaces or choose which workspace(s) to present in the calendar page and timeline. In other terms, the server may prompt the user to select the workplace thumbnail (expected location thumbnail), and, based on the selection received, display activities for further selection.

In this embodiment, each workplace offers its particular, corresponding set of ‘office spaces’ (internal locations), which are unique to the workspace (associated or corresponding to the workspace).

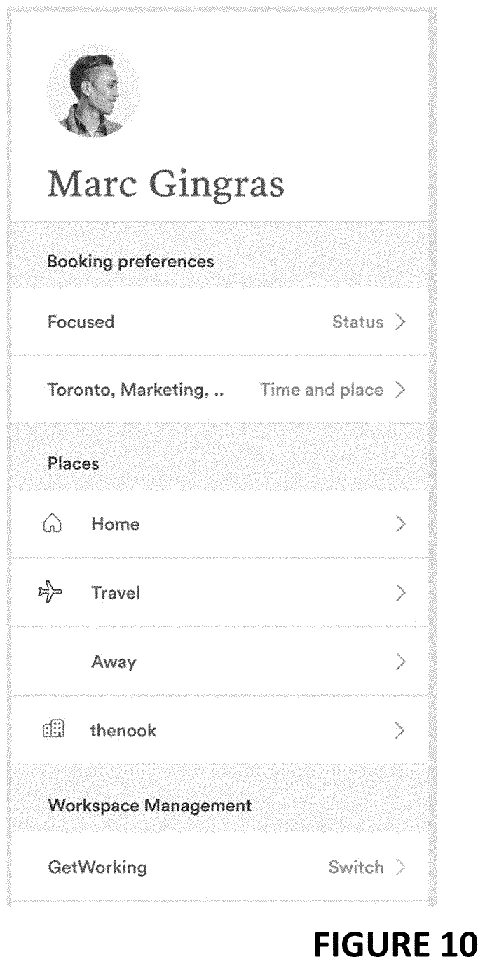

According to an embodiment, home/travel/away statuses are provisioned and managed as a user setting, as shown in the user interface of FIG. 10. Each user has a set of ‘personal’ resources (home/away/travel) which are their own (associated to the user, for each user to set their own). Visibility into these user ‘personal’ resources can then be provisioned to allow/disallow/limit visibility detail to other users, especially independent setting of the detail visibility for each one of the various workplaces of which the user may be part.

For example, in this embodiment, if the user is part of multiple workplaces, the user can create a booking to ‘Away—on Vacation—unreachable—in search of R&R’. In other words, as a result of prompts displayed to the user and the selections by the user (user's input registered at the client device 101 and then transmitted to the server 102), the server processor 805 generates a user booking which comprises various user-selected statuses and activities. Such a user booking is then conveyed to (is mapped to) multiple workplaces (in the Away section of each workplace space in the application) with a single update by the user (depending on the user configured visibility settings for sharing to a select workspace). In other words, the user booking comprising multiple user-selected statuses and activities at selected locations may be mapped, by the processor, to those selected locations. For example, when another user related to a second client device selects one of these selected locations, the user interface displayed on the client device of that second client device also displays the personal thumbnail of the first user on GUI that has selected the same location.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A method for managing occupancy of a workplace location in time, the method being executed by a server comprising a processor and a computer-readable memory storing instructions to be executed by the processor and a location-time database, the method comprising:
displaying a selection user interface at a client device for a user among a plurality of users for selecting, by the user, an expected location for a given time slot;
receiving a reservation request, at the server from the client device, the reservation request comprising an expected location identifier of the expected location and a time slot indication of the time slot;
generating and transmitting a refusal of the reservation request to the client device if a location counter is equal to a location capacity of the location, the location counter representing the number of previously received expected location identifiers of the expected location from the plurality of users;
displaying a calendar user interface with an expected location badge of the expected location for each day using personal thumbnails corresponding the plurality of users, each personal thumbnail corresponding to one user of the plurality of users, the personal thumbnails being located in the calendar user interface based on the reservation request received from each client device; and
generating and displaying, on the calendar user interface of the user display of the client device, a spatial-relationship visual indicator which maps a selection of the personal thumbnails related to users having all selected one specific location from the received expected locations, each personal thumbnail relating to a reservation of one user of the specific location having an internal location capacity, the internal location capacity being independent from the working location capacity of the workplace location.

2. The method of claim 1, further comprising generating, based on a portion of a day for which the expected location is reserved for a first personal thumbnail, and displaying a visual modifier on the first personal thumbnail, the visual modifier indicating that an expected occupancy of the expected location for which one of the first personal thumbnail is displayed in the calendar user interface is for the portion of the day only, the portion of the day being smaller than a whole day.

3. The method of claim 2, wherein the visual modifier on the at least one of the personal thumbnails displays an angular coverage which is representative of the portion of the day for which the occupancy is expected.

4. The method of claim 1, further comprising generating a timeline feed comprising a combined list of calendar reservation notifications and quick actions displayed in a chronological order.

5. The method of claim 1, further comprising generating, based on an activity received from the client device, and displaying along with the personal thumbnail, an activity indicator which represents activity or state-of-mind that the user indicated through the selection user interface.

6. A system for managing occupancy of a workplace location in time, the system comprising a server comprising a processor and a computer-readable memory storing instructions to be executed by the processor and a location-time database, the processor being configured to:
display a selection user interface at a client device for a user among a plurality of users for selecting, by the user, an expected location for a given time slot;
receive a reservation request, at the server from the client device, the reservation request comprising an expected location identifier of the expected location and a time slot indication of the time slot;
generate and transmitting a refusal of the reservation request to the client device if a location counter is equal to a capacity of the location upon receiving the expected location identifiers from the plurality of users;
display a calendar user interface with expected location badges of the expected locations for the plurality of users for each day using personal thumbnails, each personal thumbnail corresponding to one user of the plurality of users, the personal thumbnails being located in the calendar user interface based on the reservation request received from each client device; and
generate and display, on the calendar user interface of the user display of the client device, a spatial-relationship visual indicator which maps a selection of the personal thumbnails related to users having all selected one specific location from the received expected locations, each personal thumbnail relating to a reservation of one user of the specific location having an internal location capacity, the internal location capacity being independent from the working location capacity of the workplace location.

7. The system of claim 6, wherein the processor is further adapted to generate, based on a portion of a day for which the expected location is reserved for a first personal thumbnail, and displaying a visual modifier on the first personal thumbnail, the visual modifier indicating that an expected occupancy of the expected location for which one of the first personal thumbnail is displayed in the calendar user interface is for the portion of the day only, the portion of the day being smaller than a whole day.

8. The system of claim 7, wherein the visual modifier on the at least one of the personal thumbnails displays an angular coverage which is representative of the portion of the day for which the occupancy is expected.

9. The system of claim 6, wherein the processor is further adapted to generate a timeline feed comprising a combined list of calendar reservation notifications and quick actions displayed in a chronological order.

10. The system of claim 6, wherein the processor is further adapted to generate, based on an activity received from the client device, and displaying along with the personal thumbnail, an activity indicator which represents activity or state-of-mind that the user indicated through the selection user interface.
